(19) United States
(12) Patent Application Publication
(10) Pub. No.: US 2003/0086503 A1
(43) Pub. Date: May 8, 2003

(54) Apparatus and method for passing large bitwidth data over a low bitwidth datapath

(75) Inventors: Jens Rennert, Santa Clara, CA (US); Santanu Dutta, Sunnyvale, CA (US)

Correspondence Address: Corporate Patent Counsel, Philips North America Corporation, 580 White Plains Road, Tarrytown, NY, 10591, US

(73) Assignee: Koninklijke Philips Electronics N.V.

(21) Appl. No.: 10/005,942

(22) Filed: Nov. 8, 2001

(51) Int. Cl. H04K 1/10; H04L 27/28

(52) U.S. Cl. 375/260

(57) ABSTRACT

A circuit arrangement and technique are provided for passing N-bit digital data using an M-bit datapath, M being less than N. A plurality of N-bit words is arranged for transfer in two portions. A first portion of each of the plurality of words is transferred in M-bit groups. At least one other bit group is transferred, including bits from the second portions of at least two of the plurality of words. After transfer, each first portion is reassembled with a corresponding second portion into respective N-bit words. The digital data is arranged for transfer at one rate, and transferred at a second rate at least as fast as the first rate. In one embodiment, X words of data are transferred from one storage element while another X words are arranged for transfer in another storage element. In a more particular embodiment, 10-bit data is passed over a standard 8-bit digital visual interface.

### FIELD OF THE INVENTION

The present invention is directed to digital data processing, and more particularly, digital data communications techniques.

### BACKGROUND

Ongoing demands for more-complex circuits have led to significant achievements that have been realized through the fabrication of very large-scale integration of circuits on small areas of silicon wafer. These complex circuits are often designed as functionally-defined blocks that operate on a sequence of data and then pass that data on for further processing. This communication from such functionally-defined blocks can be passed in small or large amounts of data between individual integrated circuits (or “chips”), within the same chip and between more remotely-located communication circuit arrangements and systems. Regardless of the configuration, the communication typically requires closely-controlled interfaces to insure that data integrity is maintained and that chip-set designs are sensitive to practicable limitations in terms of implementation space and available operating power.

Computer arrangements, including microprocessors and digital signal processors, have been designed for a wide range of applications and have been used in virtually every industry. For a variety of reasons, many of these applications have been directed to processing video data. Many digital video processing arrangements are increasingly more complex to perform effectively on a real-time or near real-time basis. With the increased complexity of circuits, there has been a commensurate demand for increasing the speed at which data is passed between the circuit blocks. Many of these high-speed communication applications can be implemented using parallel data interconnect transmission in which multiple data bits are simultaneously sent across parallel communication paths. A typical system might include a number of modules (i.e., one or more cooperatively-functioning chips) that interface to and communicate over a parallel data bus, for example, in the form of a cable, other interconnect and/or via an internal bus on a chip. While such “parallel bussing” is a well-accepted approach for achieving data transfers at high data rates, more recently, digital high-speed serial interface technology is emerging in support of a more-direct mode to couple digital devices to a system.

One Digital Visual Interface (DVI) specification provides a high-speed digital connection for visual data types that are display technology independent. DVI was developed in response to the proliferation of digital flat-panel video displays, and a need to efficiently attach the flat-panel displays to a personal computer (PC) via a graphics card. Coupling digital displays through an analog video graphics array (VGA) interface requires a digital signal be first converted to an analog signal for the analog VGA interface, then converted back to a digital signal for processing by the flat-panel digital display. The double-conversion process takes a toll on performance and video quality, and adds cost. In contrast, no digital-to-analog conversion is required in coupling a digital flat-panel display via a digital interface. As digital video displays, such as flat-panel displays and digital CRTs, become increasingly more prevalent, so do digital interfaces, such as the DVI interface.

The DVI uses a high-speed serial interface implementing Transition Minimized Differential Signaling (TMDS) to provide a high-speed digital data connection between a graphics adapter and display. Display (or pixel) data flows from the graphics controller, through a TMDS link (implemented in a chip on the graphics card or in the graphics chip set), to a display controller. TMDS conveys data by transitioning between “on” and “off” states. An advanced encoding algorithm that uses Boolean exclusive OR (XOR) or exclusive NOR (XNOR) operations is applied to minimize the transitions. Minimizing transitions avoids excessive Electro-Magnetic Interference (EMI) levels on the cable. An additional operation is performed to balance the DC content. Input 8-bit data is encoded for transfer into 10-bit transition-minimized, DC-balanced (TMDS) characters. The first eight bits are the encoded data, the ninth bit identifies whether the data was encoded with XOR or XNOR logic, and the tenth bit is used for DC balancing.

The TMDS interconnect layer consists of three 8-bit high-speed data channels (for red, green, and blue pixel data) and one low-speed clock channel. DVI allows for up to two TMDS links, each link being composed of three data channels for RGB information and having a maximum bandwidth of 165 MHz. DVI provides improved, consistent image quality to all display technologies. Even conventional CRT monitors are implementing the DVI interface to realize the benefits of a digital link, a sharper video image due to fewer errors and less noise across the digital link.

While a standard DVI connection handles 8-b digital data inputs (excluding TMDS encoding), some advanced hardware and applications (e.g., digital TV, digital set-top boxes, etc.), particularly those for high-definition pictures calling for enhanced resolution, require communication of 10-bit digital data (excluding TMDS encoding). For example, digital data encryption protects digital data flowing over a digital link from a video source (such as a PC, set-top box, DVD player, or digital VCR) to a digital display (such as an LCD monitor, television, plasma panel, or projector), so that the content cannot be copied. Data is encrypted at the digital link's transmitter input, and decrypted at the link's receiver output. However, certain encryption techniques extend data bitwidths. High-bandwidth digital content protection (HDCP) adds two additional bits. For example, two bits are added during encryption to 8-bit input data for a total of 10 bits. HDCP encryption adds two additional bits, for a total of 10 bits. TMDS encoded 10-bit data for each of the three pixel components, R, G, and B for transfer using HDCP encryption requires another two bits, for a total of 12 bits. However, no 10-bit (excluding TMDS encoding) DVI connection standard presently exists by which to pass 10-bit data over a TMDS link.

Accordingly, improving data transfer interfaces permit more practicable and higher-speed communication applications which, in turn, can directly lead to serving the demands for high-speed circuits while maintaining data integrity. Various aspects of the present invention address the above-mentioned deficiencies and also provide for communication methods and arrangements that are useful for other applications as well.

### SUMMARY

The present invention is directed to a digital data interface that addresses the above-mentioned challenges and that provides a method for communicating data having a bitwidth larger than the datapath's bitwidth. The present invention is exemplified in a number of implementations and applications, some of which are summarized below.

According to one example embodiment of the present invention, N-bit word data is passed over an M-bit channel, M being less than N. Each N-bit word has a first portion and a second portion. The first portion of each of a plurality of X words is transferred in M-bit groups, and at least one other bit group that includes bits from the second portions of at least two of the X words is also transferred. The second portion for each of the X words is extracted from the transferred at least one other bit group and joined to the corresponding transferred first portion to reassemble the N-bit word data.

According to other aspects of the present invention, the bit-length of the first portion is an integer multiple of M. The bit-length of the second portion is less than M. The first portion includes M bits of encoded information, and the second portion includes encoding and DC content balancing information. In one implementation, the at least one other bit group includes M bits.

According to other aspects of the present invention, X is an integer and multiple of M/(N−M). According to a more specific example embodiment, the present invention is directed to a 10-bit digital data is passed over an 8-bit channel, and X is 4. In a further embodiment, the channel includes a standard Digital Visual Interface (DVI). The first portion is typically a most-significant bits portion, the second portion being a least-significant bits portion. In an alternate arrangement, the first portion is the least-significant bits portion, and the second portion is the most-significant bits portion.

In accordance with other aspects of the present invention, the N-bit word data is stored in X locations at a first rate. Each location is N-bits wide, each N-bit word being stored in one of the X locations. Groups of the N-bit word data are transferred from the X locations at a second rate. In one example implementation, the second rate is at least as fast as the first rate. In a further example implementation, the second rate is faster than the first rate. In a still further example implementation, the second rate is N/M time faster than the first rate. The first portion of each of X words are transferred in a sequence corresponding to an order by which each of X words was provided, according to another aspect of the present invention.

According to a more specific example embodiment, the present invention is directed to arranging, for transfer, a first quantity of X words in a first storage element, the words each having N-bits. While transferring the first portion of each of the X words and at least one other bit group, another quantity of X words is arranged for transfer in another storage element. For each of the X words, the second portion is extracted from the transferred at least one other bit group and joined to the corresponding transferred first portion.

According to another example embodiment, the present invention is directed to an apparatus for passing N-bit word data over an M-bit channel, M being less than N. Each N-bit word has a first portion and a second portion. A first circuit arrangement is adapted to transfer the first portion of each of X words in M-bit groups. A second circuit arrangement is adapted to transfer at least one other bit group, including bits from the second portions of at least two of the X words. A receive circuit arrangement is adapted to extract the second portion from the transferred at least one other bit group, and join the second portion to the corresponding transferred first portion for each of the X words.

Other aspects and advantages directed to specific example embodiments of the present invention.

The above summary of the present invention is not intended to describe each illustrated embodiment or every implementation of the present invention. The figures and detailed description that follow more particularly exemplify these embodiments.

### BRIEF DESCRIPTION OF THE DRAWINGS

The invention may be more completely understood in consideration of the detailed description of various embodiments of the invention, which follows in connection with the accompanying drawings. These drawings include:

FIG. 1 illustrates a block diagram of an example interface incorporating a standard DVI interface, according to the present invention.

FIG. 2 illustrates a general block diagram of an example interface between an N-bit data stream and an M-bit datapath, according to the present invention.

FIG. 3 illustrates a clock-relationship timing diagram of an example interface between an N-bit data stream and an M-bit datapath, according to the present invention.

FIGS. 4-7 illustrate timing diagrams of an example interface showing synchronization between data-provide and data-transfer operations, according to the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DISCLOSED EMBODIMENTS

The present invention is believed to be applicable to a variety of different types of digital communication applications, and has been found to be particularly useful for digital video interface applications benefiting from a technique for passing relatively larger bitwidth data over a datapath having a relatively smaller bitwidth capability. More particularly, the present invention is believed to be applicable to digital datapaths wherein a desire to communicate richer information via larger-bitwidth data, for example higher-resolution or encoded images, precedes implementation of digital communication channels and standards to accommodate such data. Various aspects of the invention may be appreciated through a discussion of examples using these applications.

According to a general example embodiment of the present invention, a circuit arrangement passes N-bit digital data over an M-bit datapath, M being less than N, using switching, multiplexing, and clocking logic to arrange the digital data into relatively smaller groups of data at a transmission end of the datapath. For example, the N-bit data is parsed into M-bit groups for transmission over the M-bit datapath. At least one group of data is arranged for transfer into a group comprised of bits extracted from a plurality of the input N-bit words. The relatively smaller data groups are subsequently reassembled back into N-bit words at a receiving end.

A buffer arrangement, located across a clock domain boundary, is used at each end of the datapath for grouping and reassembly operations respectively. The transfer clock domain is at least as fast as the clock domain feeding the transmission end of the datapath. Digital data is provided into the transmission buffer arrangement at one rate (e.g., written according to a “write clock), and transferred from the buffer for transmission over the communication channel at another, faster, rate (e.g., clocked out according to another, “read clock”). In one more specific arrangement, the percentage difference between the input rate and the transfer rate is proportional to the percentage difference between the bitwidth of the input digital data words and the datapath bitwidth. The relatively smaller sized digital data groups are transferred through the datapath at a faster rate, in compensation for the changes in bit throughput due to the reduced quantity of bits per transfer through the datapath. In one example implementation, the percentage difference between bitwidths is compensated for by an equivalent increase in speed between the first (input) rate and the second (transfer) rate. For example, if the input data stream bitwidth is 25% larger than the datapath bitwidth, the transfer rate through the datapath (e.g., read clock) is 25% faster than the data stream input rate (e.g., write clock), thus maintaining a bit throughput across the datapath equivalent to the incoming data stream throughput.

According to other aspects, each N-bit word of input digital data is delineated into a first portion and a second portion, the first portion being a quantity of bits that is a multiple of M, and the second portion being a quantity of less than M bits. A plurality of first portions (e.g., from each of X words) are transmitted M-bits at a time. For example, a first portion having M bits is transferred in one, M-bit group. A first portion having 2M bits is transferred in two groups of M bits. Bits from a plurality of second portions are arranged (i.e., concatenated together) and transferred in at least one other bit group, each of the bit group(s) having at most M bits. For example, the second portions of all X words joined together in an M-bit group for transmission. In another example, the second portions of all X words joined together in an group for transmission, the group having less than M bits. In yet another example, bits from second portions of at least two of the X words are arranged (i.e., concatenated, or joined together) as a group and transferred, the group having at most M bits.

At the receiving end of the datapath, the transferred data is un-arranged back into N-bit words. The process of un-arranging corresponds to the data arranging process at the transmission end of the datapath. For example, bits of second portions are extracted from the transferred at least one additional (i.e., non-first portion) groups, and reassembled to their respective first portions in an appropriate order, to re-form respective N-bit data words.

According to other specific aspects of the present invention, X is an integer and is a function of the input data bitwidth, N, and the channel bitwidth, M. X is a multiple of the ratio M/(N−M) in one example implementation. In one more-particular example implementation, 10-bit input digital data is passed over an 8-bit channel, the digital data being arranged for transfer parsing X word groups, X being a multiple of 8/(10-8)=8/4=4. Since the ratio results in an integer directly, groups of 4 input words are arranged for transfer where the input data has a bitwidth of 10 bits, and an 8-bit channel is used.

According to a more specific example embodiment, the circuit arrangement of the present invention includes a datapath having a Digital Visual Interface (DVI) interface portion. The DVI interface portion includes a DVI link, and is equipped with HDCP using the transition-minimized TMDS signaling protocol to maintain the output data stream's stable, average dc value. TMDS is implemented by an encoding algorithm that converts 8 bits of data into a 10-bit, transition-minimized, dc-balanced character for data transmission over copper and fiber-optic cables. Transmission over the DVI link is serialized, and optimized for reduced EMI across copper cables. Clock recovery at the receiver end exhibits high skew tolerance, enabling the use of longer cable lengths, as well as shorter low-cost cables.

In accordance with other aspects of the present invention, input digital data (e.g., a plurality of N-bit words) is provided at a first rate. According to one example implementation, input N-bit word data is stored in X registers of a storage element such as a memory or buffer. Each location is adapted to store N-bits. An N-bit word is thereby stored in each of the X locations. Portions of the N-bit words are transferred in groups from the X locations at a second rate. In one example implementation, the second rate is at least as fast as the first rate. In a further example implementation, the second rate is faster than the first rate. In a still further example implementation, the second rate is N/M time faster than the first rate. A first portion of each of X 10-bit words are transferred in a pre-determined sequence in one example implementation, for example in a sequence corresponding to an order by which each of the X words was provided (e.g., written to the storage element).

According to a further general example embodiment of the present invention, a first quantity, X, of N-bit words is arranged, in a first storage element, for transfer across an M-bit datapath as described above, M being less than N. Transfer is accomplished in groups having at most M bits, as described above. Concurrently with transfer of data from the first storage element (e.g., the first portions and at least one other bit group derived from the second portions of the X words), another quantity of X words is arranged for transfer in another storage element. The input data stream is diverted to locations of the other storage element by a selecting device in one example implementation. The other quantity of X words is subsequently transferred across the datapath using the same data-grouping techniques set forth above for transferring data across the datapath from the first storage element. If more data is pending transfer, concurrent with each data transfer operation from one storage element, X words are provided into the other storage element. Concurrent transfer/provide operations alternate between two storage elements in one example implementation. The process continues to process an input data stream, alternating between providing and arranging data for transfer in the first storage element while transferring data from the second storage element, and arranging data for transfer in the second storage element while transferring data from the first storage element. For each quantity of X words, the second portions are extracted from the transferred at least one other bit group and joined to the corresponding transferred first portions to reassemble the quantity, X, of N-bit words.

According to another example embodiment, the present invention is directed to an apparatus for passing N-bit word data over an M-bit channel, M being less than N. The apparatus is adapted to parse each N-bit word into a first portion and a second portion. A first circuit arrangement is adapted to transfer the first portion of each of X words in M-bit groups. A second circuit arrangement is adapted to transfer at least one other bit group, including bits from the second portions of at least two of the X words. A receive circuit arrangement is adapted to extract the second portion from the transferred at least one other bit group, and join the second portion bits to the corresponding transferred first portion for each of the X words, thereby reassembling N-bit words at the receiving end.

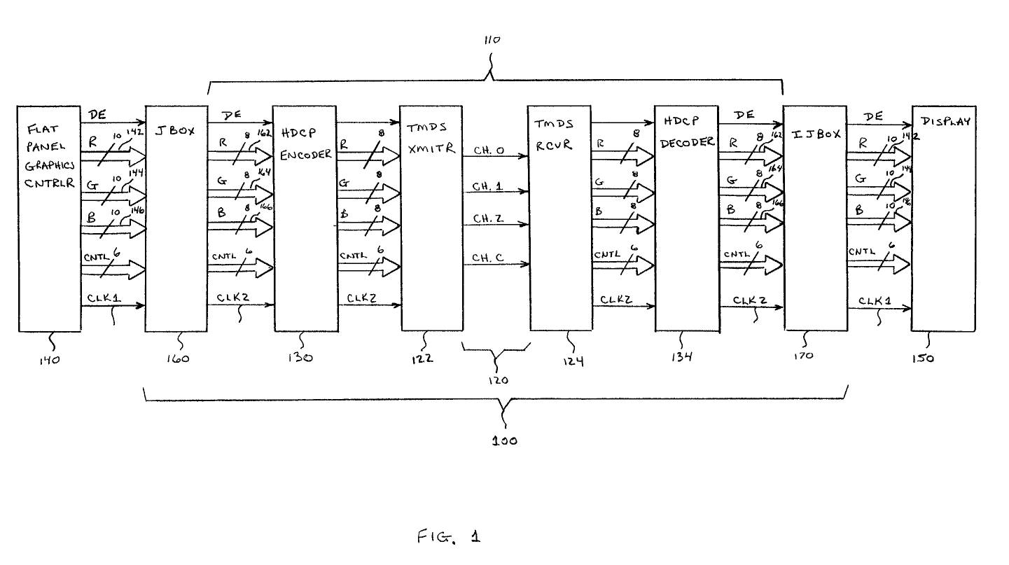

FIG. 1 illustrates an example embodiment of a circuit arrangement 100 the present invention to transfer 10-bit (“10-b”) digital data over an 8-bit (“8-b”) channel, the channel including a portion 110 implementing an 8-b DVI standard. Channel portion 110 includes a Transition Minimized Differential Signaling (TMDS) data link 120. Data is transmitted over the TMDS link by a TMDS transmitter 122, and received by a TMDS receiver 124, each being respectively coupled to the TMDS link. A high-bandwidth digital content protection (HDCP) encoder 130 is coupled to the TMDS transmitter, and an HDCP decoder 134 is coupled to the TMDS receiver for encoding and decoding digital data respectively.

A data source 140 (e.g., a flat panel graphics controller) provides a plurality of 10-b digital data streams to be transferred to a data sink 150 (e.g., a digital, flat panel display or CRT) through circuit arrangement 100. Red (R) video image information is carried on data stream 142, green (G) video image information is carried on data stream 144, and blue (B) video image information is carried on data stream 146. In an alternative implementation Y, U, and V signal information is respectively carried on three digital data streams.

A switching, multiplexing, and clocking scheme is implemented using a junction box (JBOX) 160 on the transmitter side and its complement, an inverse JBOX (IJBOX) 170 on the receiver side. The function of the JBOX is to disassemble each of the 10-b data streams communicated via datapaths (e.g., 142, 144, and 146) into corresponding 8-b data streams communicated via datapaths 162, 164, and 166 respectively, that the standard DVI interface can easily transport without modifications. On the receiver side, the 8-b data streams from the TMDS receiver via the HDCP decoder, are once again reassembled into respective 10-b data streams.

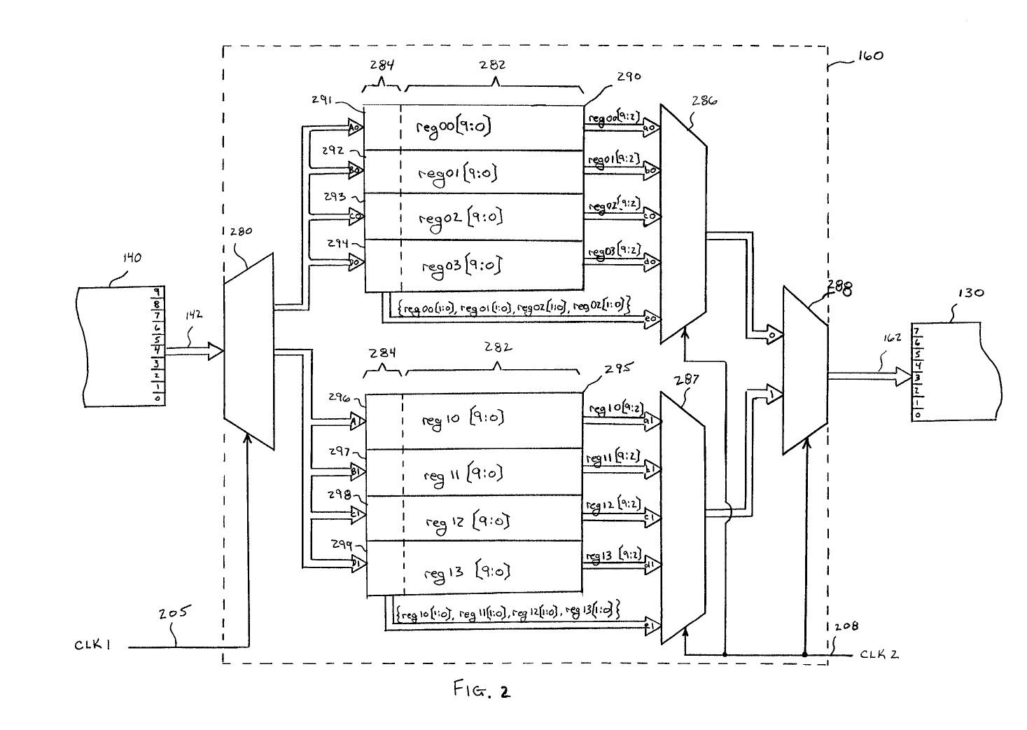

Referring now to FIG. 2, consider in example one of three (R, G, and B; or Y, U, and V) 10-b digital data streams shown in FIG. 1. JBOX 160 of circuit arrangement 100 parses a plurality, X, of consecutive 10-b data words into smaller 8-b groups for transfer. In one example implementation, a total of 40 bits are arranged into five 8-b data groups, each of the first four 8-b groups being the eight most significant bits (MSBs) of one of the four 10-b words. The last (fifth) 8-b group comprises the two least significant bits (LSBs) from each of the four 10-b data words.

The 10-b words are provided from data source 140 (e.g., flat panel graphics controller), coupled to a demultiplexer (“demux”) 280 via 10-bit datapath 142. Demultiplexer 280 is coupled to a first buffer (buffer 0) 290, and a second buffer (buffer 1) 295. Sequential 10-b words are provided into first buffer 290, and subsequently to second buffer 295. The buffers each include X 10-b registers, in this implementation four 10-b registers, registers 291, 292, 293 and 294 in the first buffer, and registers 296, 297, 298 and 299 in the second buffer. Each of the registers is adapted to store one 10-b data word. Register 291 is register 0 of buffer 0; therefore the 10 bit locations of register 291 can be referenced as reg00[9:0], connoting bits zero through nine of register zero within buffer zero. Similarly, reg13[9:0] connotes bits zero through nine of register three (i.e., register 299) within buffer one (i.e., buffer 295).

The magnitude of X is designed based upon the relative difference between the input data stream bitwidth and the datapath bitwidth. For greatest efficiency, X is selected to be a multiple of M/(N−M), for example the smallest multiple of M/(N−M) that is an integer, so that bits extracted from second portions can be grouped into M-bit groups. Datapath capacity is wasted, therefore transfer efficiency is reduced, if bits extracted from second portions are grouped having less than M-bits. In the embodiment illustrated in FIG. 2, M is 8 and (N−M) is 2, therefore M/(N−M) is 8/2, or 4. This is also the lowest multiple (1×) that is an integer. However, for a 7-bit channel, M/(N−M) is 7/3, or 2.33. The lowest multiple that is an integer is 3×, or 7. Therefore implementing the storage elements having 7 locations is most efficient.

Within buffer 290, register 291 is selected by demux 280 for filling, then register 292, and so on in an order indicated by arrowheads A0, B0, C0, and D0 for buffer 290. The data paths for filling the registers of buffer 295 are similarly referenced to indicate an example implementation having sequential buffer filling. Through demux 280, buffers 290 and 295 are sequentially filled from a single 10-b data stream. Buffers 290 and 295 are optionally filled in another fixed order, requiring reassembly operations at the receiving end of the datapath to correspond to the particular order.

The data in each register is delineated into first and second portions, a most-significant bits portion (MSB) 282, and a least-significant bits (LSB) portion 284, for example. Delineation can be physically-implemented, or logically implemented according to bit address. For example in another example implementation, each buffer is a single 40-b element, and first and second portions are delineated logically by address, or some other identification tracking technique. Buffers 290 and 295 need not be discrete elements, and may be implemented in a variety of configurations including allocated address locations within a larger, multi-purpose memory structure.

Data is provided to the circuit arrangement of the present invention at a first rate. For example, data is stored or written into buffers 290 and 295, through demux 280, at a first rate according to a first clock signal, CLK1, received on first clock signal path 205. One buffer, for example buffer 290, is filled first. Once one buffer is filled, data transfer operations from the filled buffer (e.g., buffer 290) execute concurrently with filling operations into the other buffer (e.g., buffer 295). Data transfer from buffer 290 is complete in the time necessary to fill buffer 295, so that once buffer 295 is filled, demux 280 can once again select buffer 290 for filling without unnecessary delay. Data is transferred from buffer 295, and buffer 290 is re-filled concurrently. The concurrent fill/transfer operations proceed continuously, alternating fill/transfer operations between the two buffers. In another example embodiment, only one buffer is used with some delay between filling and transfer operations as necessary for coordination of the fill/transfer operations. In another example embodiment, a single buffer is implemented, and concurrent fill/transfer operations alternate between two portions of the single buffer. In yet another example embodiment, more than two buffers are used to prevent data overflow, the buffer filling/data transfer operations being coordinated in a manner similar to that described above, but in a round-robin, rather than alternating order.

In the example embodiment illustrated in FIG. 2, data is transferred out of buffer 0 in a pre-defined order, as is indicated in FIG. 2 by arrowheads a0, b0, c0, d0, and e0. As illustrated, the first portion of register 291 is the eight MSBs stored in reg00[9:2], and the second portion is the two LSBs stored in reg00[1:0]. Recalling that the downstream datapath (i.e., HDCP encoder 130 and beyond) has a bitwidth of eight, the first portion of register 291 is transferred first, followed by the first portions of registers 292, 293, and 294 respectively as indicated by arrowheads a0-d0. Another bit group is formed using bits from the second portions 284 of the data stored in the registers of buffer 290. As indicated in FIG. 2, the second portions are concatenated together (“{ }” connotes concatenation) to form an 8-b word for transfer over the downstream 8-b datapath.

As will be appreciated by those skilled in the art, the filling/transferring operations are decoupled via buffers 290 and 295. The specific order by which the 8-bit groups transferred from buffer 290 is secondary to maintaining correspondence between respective first and second portions throughout parsing and re-assembly operations. For example in another example embodiment of the present invention, the order of transfer is the first portion of register 294, then 293, 292, 291, and finally, the 8-b word formed from the second portions. In yet another example embodiment, the second portions are transferred before transferring the first portions. The various orders by which parsed groups may be sent, are simply matched at the receiving end of the datapath with an appropriate re-assembly routine to sort and reassemble N-bit words, then pass them along in the order they were initially received.

Data from each of the registers of buffer 290, plus the second portion concatenation, are sequentially selected by multiplexer (“mux”) 286 for transfer and coupled through to mux 288. Similarly, data from each of the registers of buffer 295, plus the second portion concatenation, are sequentially selected by mux 287 and coupled through to mux 288. Mux 288 is coupled via datapath 162 and HDCP encoder 130 to the bitwidth-limited downstream datapath (e.g., TMDS data link 120). Muxes 286, 287, and 288 are operated according to the transfer clock signal, CLK2, received via transfer clock signal path 208.

The “ping-pong” timing mechanism, used to process subsequent groups of four 10-b input words, utilizes 2 separate clocks in the example embodiment illustrated. The clocks have a fixed frequency ratio. Four 10-b data words are clocked according to the slower CLK1 signal into the JBOX, and are collected in one buffer (e.g., buffer 290) in 4 cycles. However, five 8-b groups must be clocked out of buffer to transfer all the information contained in the four 10-b data words. The five 8-b groups are read out of buffer 290 using faster clock signal, CLK2. These 8-b data groups are streamed into the standard DVI interface.

The buffer-fill rate (e.g., clock signal CLK1) time period is denoted as T1, and the transfer rate (e.g., clock signal CLK2) time period is denoted as T2. To prevent overwriting a buffer during transfer operations, or transferring incorrect data, buffer fill and transfer operations are designed to have the same duration. Therefore, 4×T1 must equal 5×T2, thereby implying a clock time period ratio T1/T2=5/4. Denoting the frequency by F1 for buffer-fill rate, and F2 for transfer rate, and noting that frequency is defined as the inverse of period (i.e., F=1/T), T1/T2=(1/F1)/(1/F2)=F2/F1=5/4=1.25. Therefore, the transfer rate (e.g., clock signal CLK2) must be 1.25 times faster than the buffer-fill rate (e.g., CLK1). This ratio is easily implemented using a fractional-frequency multiplier.

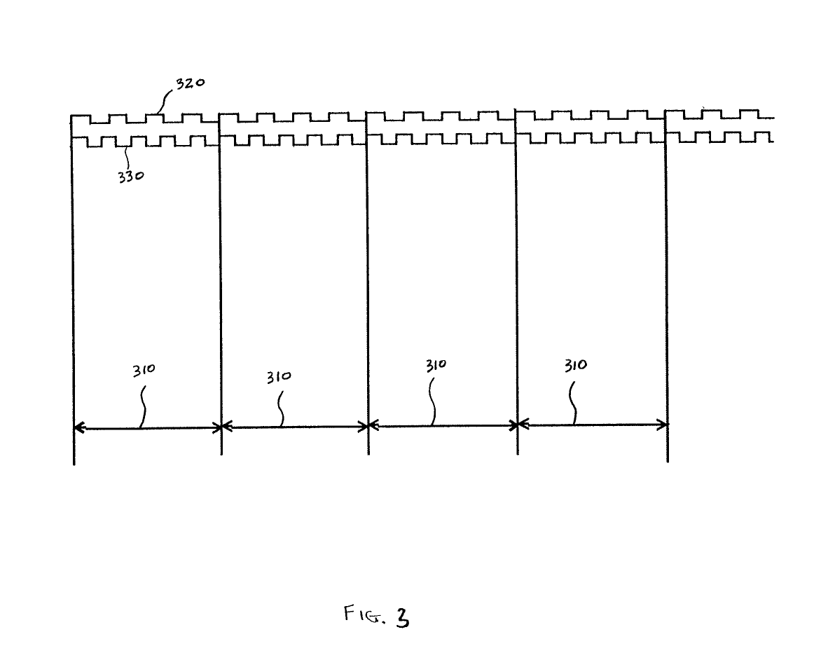

FIG. 3 illustrates timing relationships between the clock signal for data-providing operations 320, and the clock signal used for data transferring operations 330 in one example embodiment. A phase alignment window 310 includes 4 cycles of CLK1 320, and 5 cycles of CLK2. The phases of the two clock signals are aligned using a phase aligner in one example arrangement, so that the clock edges line up every 4 cycles of T1, and 5 cycles of T2, within the phase-alignment window.

Upon initially receiving data in one of the buffers, 290 or 295, transfer from the buffer (e.g., reading of the buffer) is started only after a write logic control (not shown) signals to a read logic control (not shown) that sufficient data is available in the filled buffer to commence transfer (i.e., read) operations. Once read operations start, read operations proceeding according to the transfer clock signal CLK2 and write operations proceeding according to the providing clock signal CLK1 for a particular buffer continuously. A constant time interval is maintained therebetween.

Transfer (e.g., read) operations from a buffer may commence some delay period after data is provided (e.g., written) to a buffer, to assure that transfer operations do not overtake buffer-fill operations. In one implementation, transfer operations occur after all buffer registers are full. In another implementation, transfer operations occur after one or more registers of a buffer contain data. Transfer operations may be commenced beginning at one of four possible CLK1 clock edge positions within a phase-alignment window. The transfer includes a write in the CLK1 clock domain and a read in the CLK2 clock domain. Synchronization of a read-start signal from the CLK1 clock domain to the CLK2 clock domain is necessary to reduce the chances of metastability. Double-registering of the read-start control signal provides clock-domain synchronization without need for pulse-stretching since the transfer is from a relatively-slower clock domain to a relatively faster clock domain.

A further synchronization mechanism is implemented via double buffering, the “ping-pong” alternation between the two buffers, 291 and 296 in FIG. 2. While data is transferred from one buffer (e.g., data is being read from the buffer), new data is being provided to the other buffer. Double buffering using a plurality of buffering arrangements prevent transfer operations from conflicting with buffer-fill operations, including ensuring that the transfer operations will neither surpass the data-providing operations, attempting to transfer data that has not yet been provided, nor will transfer operations fall too far behind in the alternating operation of the circuit arrangement of the present invention whereby data is overwritten in a buffer location for example, before previous data at that buffer location is transferred out of the buffer to the datapath. The combination of double registering and double-buffering works because the transfer clock domain is relatively faster than the buffer-fill clock domain. In one example implementation, the percentage difference between the ratio of the two clock domain frequencies is exactly equal to the ratio of the transfer bitwidth to the transfer bitwidth. A latency of 2 cycles results from the double registering for clock domain synchronization of the read-start control signal, so that raising the read-start flag (to initiate transfer operations) coincident with data being provided (e.g., written) into the second register (reg01) of buffer 0, delays transfer (e.g., reading) of the first group of data until approximately the same time that buffer 0 is almost full.

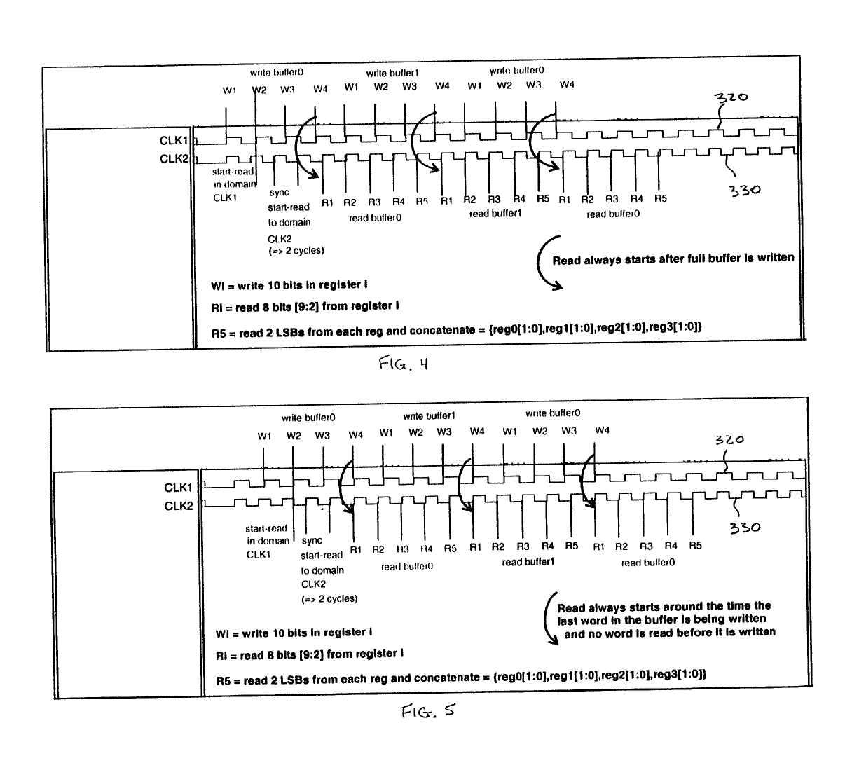

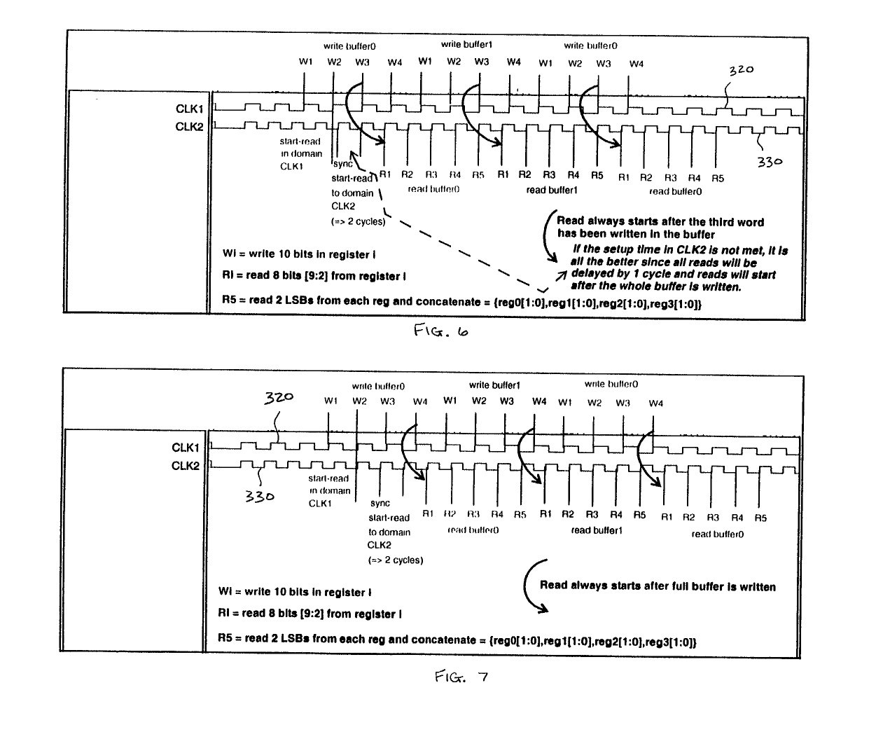

Together, asserting a read-start signal at the same time that the second register in a buffer is provided with new data in clock domain CLK1, and the approximately 2 cycle double registering delay for the read-start signal to get synchronized and recognized in clock-domain CLK2 in order to initiate the read operation, ensure that the transfer operations never conflict with buffer-fill operations. FIGS. 4-8 respectively illustrate that transfer operations may be successfully commenced at any of the four possible CLK1 clock edge positions within a phase-alignment window (clock domains having T1/T2=5/4 are illustrated).

Accordingly, various embodiments of the present invention can be realized to provide faster addition for a series of signed and unsigned binary arithmetic executed, for example in video signal processing, cryptography, and other computer-implemented control applications, among others. Generally, the circuit arrangements and methods of the present invention are applicable wherever an ALU might be used. Although particularly useful and helpful exchanging 10-b data between a high-resolution device and a standard consumer-electronics appliance including a standard DVI interface, the flexibility inherent in the methodology described herein facilitates transporting any N-bit data over an M-bit interface, where N>M. The various embodiments described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such modifications and changes do not depart from the true spirit and scope of the present invention that is set forth in the following claims.

What is claimed is:

1. A method of passing N-bit word data over an M-bit channel, M being less than N, each N-bit word having a first portion and a second portion, the method comprising:
transferring the first portion of each of X words in M-bit groups, X being at least two; and
transferring at least one other bit group, the at least one other bit group including bits from the second portions of at least two of the X words.

2. The method of claim 1, further comprising:
joining, for each of the X words, the second portion to the corresponding transferred first portion, the second portion being extracted from the transferred at least one other bit group.

3. The method of claim 1, wherein the first portion includes M bits of encoded information, and the second portion includes encoding information.

4. The method of claim 3, wherein the second portion further includes DC content balancing information.

5. The method of claim 3, wherein N is 10, M is 8.

6. The method of claim 5, wherein the M-bit channel includes a Digital Visual Interface (DVI) portion.

7. The method of claim 5, wherein the first portion is a most-significant bits portion, and the second portion is a least-significant bits portion.

8. The method of claim 1, wherein the first portion is a most-significant bits portion, and the second portion is a least-significant bits portion.

9. The method of claim 1, wherein the first portion is a least-significant bits portion, and the second portion is a most-significant bits portion.

10. The method of claim 1, wherein X is an integer and multiple of M/(N−M).

11. The method of claim 10, wherein X is 4.

12. The method of claim 1, wherein the bit-length of the first portion is an integer multiple of M.

13. The method of claim 1, wherein the bit-length of the second portion is less than M.

14. The method of claim 1, further comprising storing the N-bit word data in X locations at a first rate, each location being N-bits wide, wherein each N-bit word is stored in one of the X locations, and transferring includes reading from the X locations at a second rate, the second rate being faster than the second rate.

15. The method of claim 1, wherein the at least one other bit group includes M bits.

16. The method of claim 1, further comprising arranging for transfer the N-bit word data at a first rate, wherein transferring is at a second rate, the second rate being at least as fast as the first rate.

17. The method of claim 16, wherein the second rate is faster than the first rate.

18. The method of claim 16, wherein the second rate is N/M times faster than the first rate.

19. The method of claim 16, wherein the first portion of each of X words are transferred in a sequence corresponding to an order by which each of X words was provided.

20. The method of claim 1, further comprising:
arranging for transfer X N-bit words in a first storage element; and
arranging for transfer, while transferring the first portion of each of X words and at least one other bit group, another X N-bit words in another storage element.

21. The method of claim 20, further comprising:
for each of the X words, joining the second portion to the corresponding transferred first portion, the second portion being extracted from the transferred at least one other bit group.

22. An apparatus for passing N-bit word data over an M-bit channel, M being less than N, each N-bit word having a first portion and a second portion, comprising:
means for transferring the first portion of each of X words in M-bit groups; and
means for transferring at least one other bit group, the at least one other bit group including bits from the second portions of at least two of the X words.

23. The apparatus of claim 22, further comprising:
means for joining, for each of the X words, the second portion to the corresponding transferred first portion, the second portion being extracted from the transferred at least one other bit group.

24. The apparatus of claim 22, further comprising means for storing the N-bit word data in X locations at a first rate, each location being N-bits wide, wherein each N-bit word is stored in one of the X locations, and transferring includes reading from the X locations at a second rate, the second rate being faster than the second rate.

25. The apparatus of claim 22, further comprising means for arranging for transfer the N-bit word data at a first rate, wherein transferring is at a second rate, the second rate being at least as fast as the first rate.

26. The apparatus of claim 22, further comprising:
means for arranging for transfer X N-bit words in a first storage element; and
means for arranging for transfer, while transferring the first portion of each of X words and at least one other bit group, another X N-bit words in another storage element.

27. A apparatus for passing N-bit word data over an M-bit channel, M being less than N, each N-bit word having a first portion and a second portion, comprising:
a first circuit arrangement adapted to transfer the first portion of each of X words in M-bit groups; and
a second circuit arrangement adapted to transfer at least one other bit group, the at least one other bit group including bits from the second portions of at least two of the X words.

28. The apparatus of claim 27, further comprising:
a receive circuit arrangement adapted to join, for each of the X words, the second portion bits to the corresponding transferred first portion, the second portion bits being extracted from the transferred at least one other bit group.

29. The apparatus of claim 27, further comprising a storage element adapted to store the N-bit word data in X locations at a first rate, each location being N-bits wide, wherein each N-bit word is stored in one of the X locations, and transfer includes reading from the X locations at a second rate, the second rate being faster than the second rate.

30. The apparatus of claim 27, further comprising another circuit arrangement adapted to arrange for transfer the N-bit word data at a first rate, wherein transferring is at a second rate, the second rate being at least as fast as the first rate.

31. The apparatus of claim 27, further comprising:
a circuit arrangement adapted to arrange for transfer X N-bit words in a first storage element; and
a circuit arrangement adapted to arrange for transfer, while transferring the first portion of each of X words and at least one other bit group, another X N-bit words in another storage element.
